(19) United States
(12) Patent Application Publication
(10) Pub. No.: US 2007/0264071 A1
(43) Pub. Date: Nov. 15, 2007

(54) Split Case, Case Decomposing Device and Tape Cartridge

(75) Inventor: Hideyuki TAKAHASHI, Omachi-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/690,021

(22) Filed: Mar. 22, 2007

(30) Foreign Application Priority Data
May 12, 2006 (JP) 2006-133521

(51) Int. Cl. H01R 13/62

(52) U.S. Cl. 400/208; 439/157

(57) ABSTRACT

A split case includes a first case and a second case to be joined to each other so as to be decomposable, includes in a joint portion between the first case and the second case: first press-fitting projections formed on a joint end surface of the first case; press-fitting holes formed at positions corresponding to the first press-fitting projections so as to penetrate through the second case for separably press-fitting the first press-fitting projections; and a plurality of through holes formed only through the first case at a plurality of portions on the joint portion.

The entire disclosure of Japanese Patent Application No. 2006-133521, filed May 12, 2006, is expressly incorporated by reference herein.

### BACKGROUND

1. Technical Field

The present invention relates to a split case having a first case and a second case to be joined to each other, a case decomposing device, and a tape cartridge.

2. Related Art

In the related art, there is a known split case (tape cartridge) including a first case (upper case) and a second case (lower case) to be joined to each other in which first press-fitting projections formed on a joint end surface of the first case, press-fitting holes (through holes) formed on the joint end surface of the second case so as to penetrate through the second case corresponding to the first press-fitting projections for separably press-fitting the first press-fitting projections, and a plurality of hooking portions formed along a contour of the first case in the shape of recesses corresponding to a contour of the second case are provided. There is also proposed a decomposing device that decomposes the split case including a set portion having the plurality of hooking portions facing the respective hooking portions of the split case and holding only the second case, and a push head having push pins for pushing the press-fitting projections out from the press-fitting holes simultaneously.

JP-A-2002-53249 can be cited as an example of the related art.

When the split case configured as described above is decomposed by the decomposing device, it is necessary to hold the split case by the set portion in the positioned state so as to allow the push pins to be inserted adequately into the press-fitting holes. In this point, the decomposing device in the related art has a configuration to hold the plurality of hooking portions of the split case by the plurality of hooking portions, and the split case cannot be positioned sufficiently with these hooking portions. Therefore, it is necessary to further provide a member for positioning by guiding the outline of the split case (positioning block). Therefore, the number of parts of the decomposing device increases, and hence increase in cost is resulted.

### SUMMARY

An advantage of some aspects of the invention is that a split case which can be decomposed adequately with a decomposing device of a simple structure, a case decomposing device, and a tape cartridge are provided.

A split case according to an aspect of the invention is a split case including a first case and a second case to be joined to each other so as to be decomposable wherein a joint portion between the first case and the second case is provided with first press-fitting projections formed on a joint end surface of the first case, press-fitting holes formed at positions corresponding to the first press-fitting projections so as to penetrate through the second case for separably press-fitting the first press-fitting projections, and a plurality of through holes formed only through the first case at a plurality of portions on the joint portion.

A case decomposing device according to an aspect the invention is a case decomposing device for decomposing the split case, including a plurality of retaining pins disposed corresponding to the plurality of through holes, a set portion for retaining only the second case by inserting the plurality of retaining pins into the plurality of through holes, a push head having push pins for pushing the press-fitting projections out from the press-fitting holes, and a moving device that causes the push head to be moved relatively with respect to the set portion.

In this arrangement, by inserting the plurality of retaining pins into the plurality of through holes of the first case, the split case is positioned and distal ends of the retaining pins inserted into the respective through holes come into abutment with the joint end surface of the second case, and only the second case is retained. By pushing the first press-fitting projections out from the press-fitting holes using the push pins in this state, the split case is decomposed. Therefore, the plurality of through holes serve not only as portions to be supported by the retaining pins at the time of decomposition of the split case, but also as positioning holes of the split case, and it is not necessary to provide a member specific for positioning the split case in the case decomposing device. Therefore, the split case may be decomposed adequately using the decomposing device having a simple structure.

Preferably, the split case shown above further including second press-fitting projections formed on the joint end surface of the second case corresponding to at least one of the plurality of through holes for being separably press-fitted to the respective plurality of through holes.

In this arrangement, the first case and the second case are joined in a state in which the plurality of second press-fitting projections are press-fitted to the plurality of through holes. Therefore, a joint force for joining the first case and the second case may be enhanced. That is, the plurality of through holes serve not only as being positioned and retained by the retaining pins when the split case is decomposed, but also as the press-fitting holes for press-fitting the second press-fitting projections for joining the first case and the second case. In this case as well, by inserting the plurality of retaining pins into the plurality of through holes of the split case, the sprit case is positioned and the distal ends of the retaining pins inserted into the respective through holes come into abutment with the distal ends of the second press-fitting projections, and only the second case is retained. By pushing the first press-fitting projections out from the press-fitting holes using the push pins in this state, a reaction force is applied to the second press-fitting projections press-fitted to the through holes to cause the same to be pushed out from the through holes via the retaining pins for supporting the same is generated, and hence the split case is decomposed. Therefore, it is not necessary to provide the second press-fitting projections and the press-fitting holes at different positions from the through holes, and limited space in the split case may be used effectively.

Since the plurality of press-fitting projections are arranged so as to be spread over the first case and the second case, even when the molded conditions of the first case and the second case are different, the joint force of the entire split case is not changed significantly For example, when the first case is formed to be larger than the second case, since the tightening margin between the first press-fitting projections and the press-fitting holes becomes larger than the design value. Therefore, the joint force of the first press-fitting projections increases. On the other hand, the tightening margin between the second press-fitting projections and the through hole is smaller than the design value, and hence the joint force of the second press-fitting projection decreases. Therefore, in terms of the entire split case, increase in joint force of the first press-fitting projections is canceled by decrease in joint force of the second press-fitting projections, so that the first case and the second case may be joined with an adequate joint force.

In this case, preferably, the plurality of first press-fitting projections and the press-fitting holes are arranged corresponding to the plurality of through holes, and the respective through holes and the respective first press-fitting projections corresponding to each other are arranged in close vicinity to each other.

In this configuration, since the corresponding first press-fitting projections and the through holes are disposed in close vicinity to each other, forces in the opposite directions from each other are applied to the press-fitting holes from which the first press-fitting projections are pushed out when the split case is decomposed and the joint end surface of the second case supported by the retaining pins inserted into the through holes. In this case, distortion of the second case which is caused by the forces in the opposite directions may be minimized. Therefore, the split case is prevented from being distorted and becoming damaged when the split case is discomposed.

A tape cartridge according to an aspect of the invention includes the split case, and a printing tape demountably stored in the split case.

In this configuration, with the employment of the split case which may be decomposed adequately using a decomposing device having a simple structure, the printing tape may be replaced easily. Accordingly, the reuse of the tape cartridge may be encouraged, which may contribute to environment protection.

### BRIEF DESCRIPTION OF THE DRAWINGS

The invention will be described with reference to the accompanying drawings, wherein like numbers reference like elements.

FIG. 1 is a perspective view of a tape cartridge according to an embodiment of the invention.

FIG. 2 is a plan view of a cartridge case decomposed into a first case and a second case.

FIG. 3 is a front view of the cartridge case decomposed into the first case and the second case.

FIG. 4 is an explanatory drawing showing a cartridge decomposing device and a tape cartridge to be mounted thereto.

### DESCRIPTION OF EXEMPLARY EMBODIMENTS

Referring now to the attached drawings, a tape cartridge and a cartridge decomposing device to which the invention is applied will be described. The tape cartridge includes a cartridge case, and a printing tape and an ink ribbon stored in the cartridge case to be mounted to a tape printer having a thermal head for printing. After the printing tape and the ink ribbon are used, the cartridge case is decomposed by the cartridge decomposing device, the used printing tape and the ink ribbon are replaced, and the cartridge case is joined again for reuse.

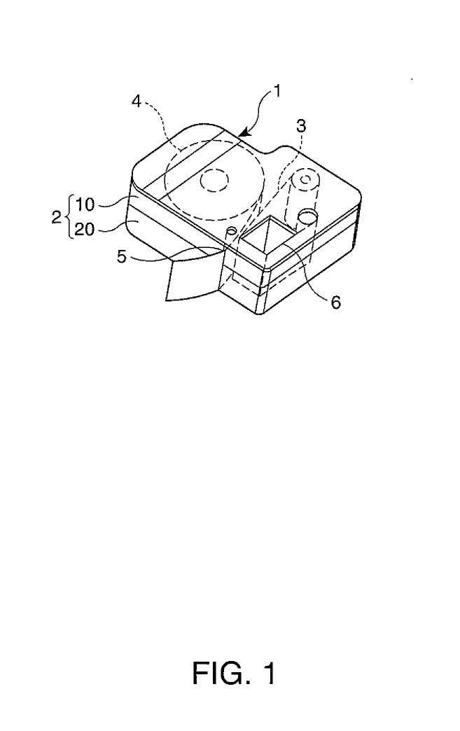

As shown in FIG. 1, a tape cartridge 1 includes a cartridge case 2 (split case) having an upper and lower halves structure which constitutes an outer shell, and an ink ribbon 3 and a printing tape 4 stored separately on the front side and the rear side in the cartridge case 2 so as to be demountable (so as to be replaceable). The printing tape 4 is wound so as to be unwoundable, and discharged from a tape exit 5 formed on the left side portion of the cartridge case 2 after printing. On the other hand, the ink ribbon 3 is wound so as to be unwoundable, and is adapted to be wound in the cartridge case 2 after printing.

The cartridge case 2 is adapted in such a manner that the tape cartridge 1 is demountably mounted to a cartridge mount formed on the tape printer, not shown, from above. The cartridge case 2 is formed with a head insertion portion 6 for inserting the thermal head when being mounted to the cartridge mount so as to penetrate therethrough.

The cartridge case 2 includes a first case 10 and a second case 20 formed of resin separately using independent metal dies, and the first case 10 and the second case 20 are joined so that joint end surfaces (a first joint end surface 17 and a second joint end surface 27, described later) abut against each other. The cartridge case 2 is mounted to the cartridge mount with the second case 20 faced downward.

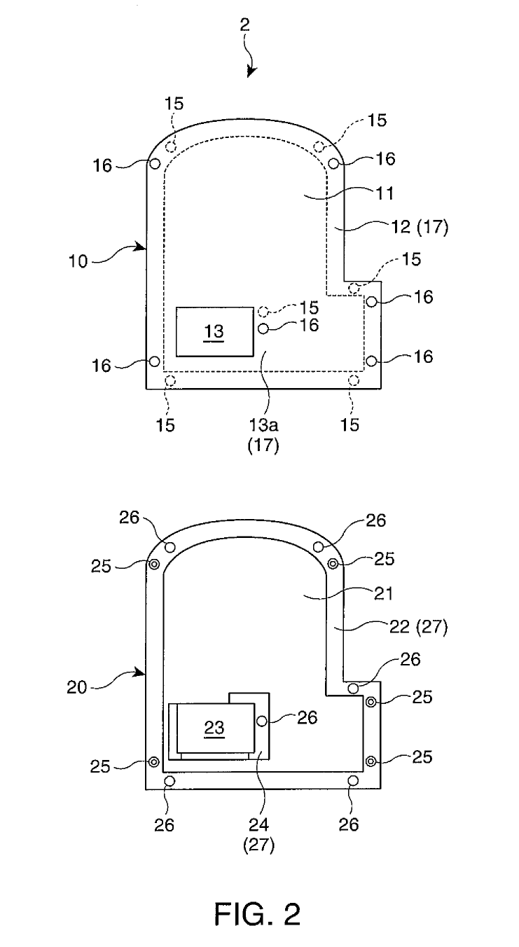

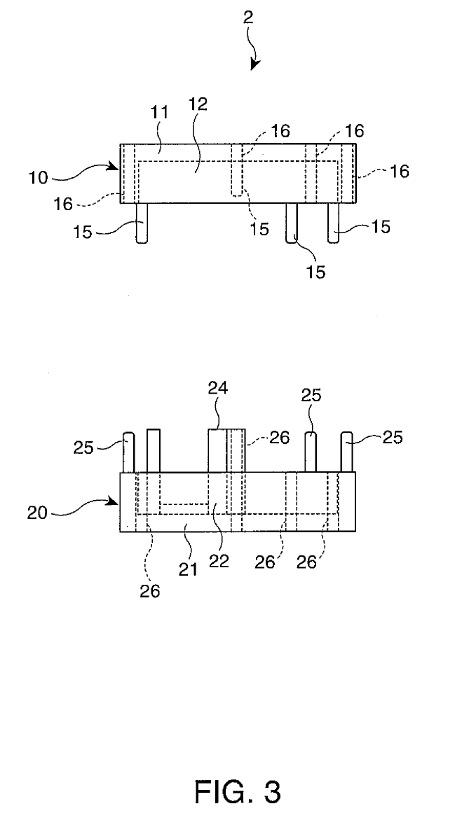

As shown in FIG. 2 and FIG. 3, the first case 10 has an integral structure including a top wall portion 11 and a first peripheral wall portion 12 projecting along the peripheral edge of the top wall portion 11. The top wall portion 11 is formed with a first head opening 13 which corresponds to the head insertion portion 6. On the other hand, the second case 20 has an integral structure including a bottom wall portion 21 and a second peripheral wall portion 22 projecting along the peripheral edge of the bottom wall portion 21. The bottom wall portion 21 is formed with a second head opening 23 which corresponds to the head insertion portion 6, and is formed with an inner wall portion 24 projecting integrally with the bottom wall portion 21 from the peripheral edge of the second head opening 23 and defining the head insertion portion 6. The inner wall portion 24 is formed to be higher than the second peripheral wall portion 22 by an extent which corresponds to the height of the first peripheral wall portion 12 so that an end surface thereof joins an edge portion 13a of the first head opening 13.

The first case 10 and the second case 20 are joined in such a manner that an end surface of the first peripheral portion 12 and an end surface of the second peripheral portion 22 abut against each other. At this time, the edge portion 13a of the first head opening 13 and the end surface of the inner wall portion 24 come into contact with each other. That is, the end surface of the first peripheral portion 12 and the edge portion 13a of the first head opening 13 of the first case 10 correspond to the joint end surface of the first case 10 (first joint end surface 17), and the end surface of the second peripheral wall portion 22 and the end surface of the inner wall portion 24 of the second case 20 corresponds to the joint end surface of the second case 20 (the second joint end surface 27). The first joint end surface 17 and the second joint end surface 27 constitutes the joint portion between the first case 10 and the second case 20.

The cartridge case 2 is provided with six first press-fitting projections 15 formed integrally with the first joint end surface 17 and six press-fitting holes 26 formed through the second case 20 at positions corresponding to the six first press-fitting projections 15 at the joint portion between the first case 10 and the second case 20, and also six through holes 16 formed only through the first case 10 at six positions at the joint portion. Furthermore, the second joint end surface 27 is formed integrally with five second press-fitting projections 25 corresponding to five from among the six through holes 16. That is, the first case 10 is formed with six each of the first press-fitting projections 15 and the through holes 16, and the second case 20 is formed with five second press-fitting projections 25 and six press-fitting holes 26. The respective first press-fitting projections 15 is separably press-fitted to the press-fitting holes 26, and the respective second press-fitting projections 25 are separably press-fitted to the through holes 16. The second press-fitting projections 25 are adapted not to be press-fitted to the through holes 16 provided at the edge 13a of the first head opening 13.

The respective first press-fitting projection 15 and the respective through holes 16 formed on the first case 10 are arranged in close vicinity to each other. That is, the six sets of first press-fitting projections 15 and the through holes 16 are distributed so as to be spread over from each other. Five sets are arranged on the end surface of the first peripheral wall portion 12 and one set is provided on the edge portion 13a of the first head opening 13. More specifically, two sets are arranged on the left and right sides of the rear portion of a storage section for the printing tape 4, two sets are arranged on the front and rear on the right portion of a storage section for the ink ribbon 3, one set at the rear right portion of the head insertion portion 6, and one set for the front left portion of the head insertion portion 6.

The respective first press-fitting projections 15 have substantially a column shape as a whole, and the distal end portions thereof are formed into a tapered shape so as to be fitted easily into the press-fitting holes 26 at the time of joining. The six first press-fitting projections 15 are formed to have predetermined lengths respectively, and are configured so as to start to be press-fitted to the six press-fitting holes 26 simultaneously at the time of joining, and to be pushed out from the six press-fitting holes simultaneously at the time of decomposing. The respective first press-fitting projections 15 are formed to be slightly shorter than the corresponding press-fitting holes 26 so that the distal ends of the first press-fitting projections 15 are press-fitted to a state staying halfway through the press-fitting holes 26.

The respective through holes 16 penetrate through the first case 10 (the first peripheral wall portion 12 or the edge portion 13a of the first head opening 13) so as to extend in the direction of the thickness of the case (vertical direction) and are opened on the first peripheral wall portion 12 (or the edge portion 13a of the first head opening 13) and the outer surface of the top wall portion 11 respectively in a circular shape.

The respective second press-fitting projections 25 and the respective press-fitting holes 26 formed on the second case 20 are arranged in close vicinity to each other except for the press-fitting holes 26 formed on the inner wall portion 24. That is, five sets of the second press-fitting projections 25 and the press-fitting holes 26 are provided on the end surface of the second peripheral wall portion 22 corresponding to the five sets of the first press-fitting projections 15 and the through holes 16 provided on the first peripheral wall portion 12. The press-fitting hole 26 formed on the inner wall portion 24 corresponds to the first press-fitting projection 15 and the through hole 16 formed at the edge portion 13a of the first head opening 13. In this manner, the six first press-fitting projections 15 and the six press-fitting holes 26 are arranged corresponding to the six through holes 16.

The respective second press-fitting projections 25 are configured in the same manner as the first press-fitting projections 15. That is, the second press-fitting projections 25 have substantially a column shape as a whole, and the distal end portions thereof are formed into a tapered shape so as to be fitted easily into the through holes 16 at the time of joining. The six second press-fitting projections 25 are formed to have predetermined lengths respectively, and are configured so as to start to be press-fitted to the six press-fitting holes 26 simultaneously at the time of joining, and to be pushed out from the six press-fitting holes 26 simultaneously at the time of decomposing. The respective second press-fitting projections 25 are formed to be slightly shorter than the corresponding through holes 16 so that the distal ends of the second press-fitting projections 25 are press-fitted to a state staying halfway through the through holes 16.

The respective press-fitting holes 26 are configured in the same manner as the through holes 16. That is, the respective press-fitting holes 26 penetrate through the second case 20 (the second peripheral wall portion 22 or the inner wall portion 24) so as to extend in the direction of the thickness of the case (vertical direction), and are opened on the second peripheral wall portion 22 (or the inner wall portion 24) and the outer surface of the bottom wall portion 21 respectively in a circular shape.

The axial direction of the respective first press-fitting projections 15 matches the axial direction of the respective press-fitting holes 26. The diameter of the respective first press-fitting projections 15 is formed to be slightly larger than the diameter of the respective press-fitting holes 26. That is, there is an adequate tightening margin between the respective first press-fitting projections 15 and the respective press-fitting holes 26. Accordingly, the first press-fitting projections 15 are press-fitted to the corresponding press-fitting holes 26, and are adapted to be separated from respective cartridge decomposing device 30 described later. The respective second press-fitting projections 25 and the respective through holes 16 are configured in the same manner.

Five from among the six through holes 16 function as press-fitting holes for press-fitting the second press-fitting projections 25 for joining the first case 10 and the second case 20 as described above. That is, the first case 10 and the second case 20 are joined in a state in which the five second press-fitting projections 25 are press-fitted to the five through holes 16. Therefore, a joint force for joining the first case 10 and the second case 20 may be enhanced. The six through holes 16 are for positioning and retaining the tape cartridge 1 by six retaining pins 36 (described later) when decomposing the tape cartridge 1 by the cartridge decomposing device 30.

Furthermore, since the plurality of press-fitting projections are arranged so as to be spread over the first case 10 and the second case 20, even when the molded conditions of the first case 10 and the second case 20 are different, the joint force of the entire cartridge case 2 is not changed significantly. For example, when the first case 10 is formed to be larger than the second case 20, since the tightening margin between the first press-fitting projections 15 and the press-fitting holes 26 becomes larger than the design value. Therefore, the joint force of the first press-fitting projections 15 increases. On the other hand, the tightening margin between the second press-fitting projections 25 and the through holes 16 is smaller than the design value, and hence the joint force of the second press-fitting projections 25 decreases. Therefore, in terms of the entire cartridge case 2, increase in joint force of the first press-fitting projections 15 is canceled by decrease in joint force of the second press-fitting projections 25, so that the first case 10 and the second case 20 may be joined with an adequate joint force.

When joining the first case 10 and the second case 20 configured in this manner, the distal end portions of the respective first press-fitting projections 15 are fitted to the corresponding press-fitting holes 26, and the distal end portions of the respective second press-fitting projections 25 are fitted to the corresponding through holes 16. When the first case 10 and the second case 20 are pressed to each other in this state, the respective first press-fitting projections 15 are press-fitted to the respective press-fitting holes 26, and the respective second press-fitting projections 25 are press-fitted to the respective through holes 16, so that the first case 10 and the second case 20 are joined. Accordingly, the first case 10 and the second case 20 are firmly tightened so as not to be separated simply by a dropping impact or the like.

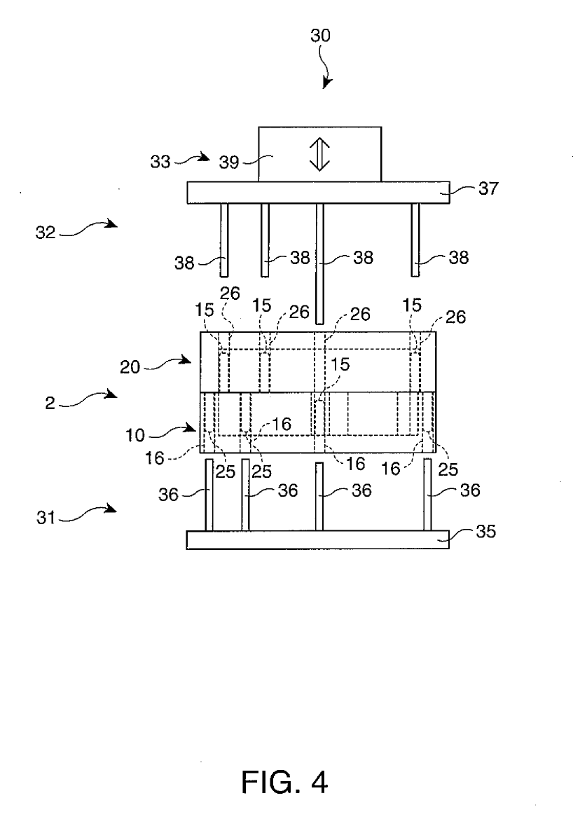

As shown in FIG. 4, the cartridge decomposing device 30 includes a set portion 31 that sets the tape cartridge 1, a push head 32 opposing the set portion 31, and an elevating mechanism 33 (moving device) that causes the push head 32 to be moved upward and downward.

The set portion 31 includes a base plate 35, and six retaining pins 36 projecting upright from the base plate 35. The six retaining pins 36 are arranged at positions corresponding to the six through holes 16 of the cartridge case 2. The respective retaining pins 36 extend in the vertical direction and are formed into a predetermined length, so as to support the cartridge case 2 horizontally.

The respective retaining pins 36 are formed of, for example, metallic material, and are longer than the thickness of the first case 10, and are formed into a column shape having a slightly smaller diameter than the through holes 16. Placing the first case 10 below and the second case 20 above, the six retaining pins 36 are inserted into the six through holes 16 from the direction opposite from the press-fitting direction of the second press-fitting projections 25, so that only the second case 20 is retained. That is, the distal ends of the respective retaining pins 36 come into abutment with the distal ends of the second press-fitting projections 25 press-fitted to the through holes 16 or the end surface of the inner wall portion 24, so that the second case 20 is supported. Furthermore, the tape cartridge 1 is positioned with respect to the push head 32.

The push head 32 includes a head plate 37 provided horizontally, and six push pins 38 implanted on the lower surface of the head plate 37. The six push pins 38 extend respectively in the vertical direction, and are arranged at positions corresponding to the six press-fitting holes 26 of the cartridge case 2.

The respective push pins 38 are formed of, for example, metallic material, and are longer than the thickness of the second case 20, and are formed into a column shape having a slightly smaller diameter than the press-fitting holes 26. When the six push pins 38 are moved downward by the elevating mechanism 33, the respective push pines 38 are inserted into the press-fitting holes 26 of the mounted tape cartridge 1 from the direction opposite from the press-fitting direction of the first press-fitting projections 15, so that the six first press-fitting projections 15 are pushed out. The six push pins 38 are formed into predetermined lengths so as to abut against the distal ends of the first press-fitting projections 15 press-fitted into the press-fitting holes 26 of the mounted tape cartridge 1 simultaneously when the head plate 37 is moved downward.

The elevating mechanism 33 includes an operation lever (not shown) provided so as to be capable of turning in the vertical direction, and a connecting portion 39 for connecting the operation lever and the head plate 37. When the operation lever is turned in the vertical direction, the push head 32 is moved upward and downward via the connecting portion 39. The connecting portion 39 is configured with a toggle link, and is configured to apply a large downward force to the mounted tape cartridge 1 only by turning the operating lever downward with a slight force.

With the cartridge decomposing device 30 configured in this manner, the tape cartridge 1 is adequately decomposed. That is, as described above, by the six retaining pins 36 inserted into the six through holes 16 of the tape cartridge 1, only the second case 20 is retained, and the tape cartridge 1 is positioned with respect to the push head 32. Accordingly, the respective push pins 38 may be inserted into the respective through holes 16 reliably, and the push pins 38 do not become damaged at the time of decomposition. In this manner, the six through holes 16 not only serve as portions to be supported by the retaining pins 36 at the time of decomposition of the tape cartridge 1, but also serve as positioning holes of the tape cartridge 1.

When the push head 32 is moved downward by the elevating mechanism 33 in this state, the six push pins 38 push the six first press-fitting projections 15 from the respective press-fitting holes 26 simultaneously, and the five second press-fitting projections 25 are also pushed out from the respective through holes 16 simultaneously. That is, by causing the first press-fitting projections 15 to be pushed out from the respective press-fitting holes 26, a reaction force is applied to the second press-fitting projections 25 press-fitted to the through holes 16 to cause the same to be pushed out from the through holes 16 via the retaining pins 36 for supporting the same is generated, and hence the tape cartridge is decomposed.

As described above, the respective sets of the first press-fitting projections 15 and the through holes 16 are arranged in close vicinity to each other, and the respective sets of the second press-fitting projections 25 and the press-fitting holes 26 are arranged in close vicinity to each other. Accordingly, when the tape cartridge 1 is decomposed, in the second case 20, a downward force is applied to the press-fitting holes 26 from which the first press-fitting projections 15 are pushed out, and an upward force is applied to the second press-fitting projections 25 supported by the retaining pins 36 which are inserted into the through holes 16 (or the end surface of the inner wall portion 24). In this case, distortion of the second case 20 which is caused by the forces in the opposite directions may be minimized. In the same manner, in the first case 10, an upward force is applied to the through holes 16 from which the push pins 38 inserted into the through holes 16 is pushed out and a downward force is applied to the first press-fitting projections 15 pushed out by the push pins 38 which are inserted into the through holes 16. However, distortion of the first case 10 due to the force in the opposite direction may be minimized. Therefore, the cartridge case 2 is prevented from being distorted and broken at the time of decomposition.

As described above, according to the tape cartridge 1 and the cartridge decomposing device 30 in this embodiment, since the tape cartridge 1 may be positioned and retained in position by the plurality of retaining pins 36, it is not necessary to provide a specific member for positioning the tape cartridge 1 in the cartridge decomposing device 30. Therefore, the tape cartridge 1 may be decomposed adequately using the cartridge decomposing device 30 having a simple structure, and the printing tape 4 and the ink ribbon 3 may be replaced easily. Accordingly, the reuse of the tape cartridge 1 may be encouraged, which may contribute to environment protection.

Although the tape cartridge 1 has been described in this embodiment, it is needless to say that the invention may be applied to various types of split cases. Among others, the invention is specifically effective for storage cases which are configured to be capable of replacing a stored object to be stored therein, such as the tape cartridge 1. For example, the invention may be applied to an ink cartridge accommodating a replaceable ink absorption member therein for being mounted to an inkjet printer.

What is claimed is:

1. A split case including a first case and a second case to be joined to each other so as to be decomposable, comprising in a joint portion between the first case and the second case:
first press-fitting projections formed on a joint end surface of the first case;
press-fitting holes formed at positions corresponding to the first press-fitting projections so as to penetrate through the second case for separably press-fitting the first press-fitting projections; and
a plurality of through holes formed only through the first case at a plurality of portions on the joint portion.

2. The split case according to claim 1, further comprising: second press-fitting projections formed on the joint end surface of the second case corresponding to at least one of the plurality of through holes for being separably press-fitted to the corresponding plurality of through holes.

3. The split case according to claim 1, wherein the plurality of first press-fitting projections and the press-fitting holes are provided corresponding to the plurality of through holes, and the respective through holes and the respective first press-fitting projections corresponding to each other are disposed in close vicinity to each other.

4. A case decomposing device for decomposing the split case according to claim 1 comprising:
a plurality of retaining pins disposed corresponding to the plurality of through holes,
a set portion for retaining only the second case by inserting the plurality of retaining pins into the plurality of through holes, a push head having push pins for pushing the press-fitting projections out from the press-fitting holes, and
a moving device that causes the push head to be moved relatively with respect to the set portion.

5. A tape cartridge comprising:
the split case according to claim 1, and
a printing tape demountably stored in the split case.
